(19) United States
(12) Patent Application Publication
(10) Pub. No.: US 2009/0182113 A1
(43) Pub. Date: Jul. 16, 2009

(54) SEGMENTED POLYURETHANE ELASTOMERS WITH HIGH ELONGATION AT TEAR

(75) Inventors: Dieter Rodewald, Hong Kong (CN); Hermann Graf, Mutterstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/298,542

(22) PCT Filed: Apr. 16, 2007
(86) PCT No.: PCT/EP07/53671

§ 371 Date: Oct. 27, 2008

(30) Foreign Application Priority Data
Apr. 25, 2006 (EP) 06113092.8

(51) Int. Cl. C08G 18/32; C08G 18/08; C08G 18/00

(52) U.S. Cl. 528/61; 528/65; 528/66

(57) ABSTRACT

The present invention relates to a process for producing a polyurethane elastomer fiber, which comprises a) reacting polymeric diol with a substance reactive therewith to form an OH-terminated prepolymer, b) reacting the OH-terminated prepolymer with a diisocyanate to form an isocyanate-terminated prepolymer, c) reacting the isocyanate-terminated prepolymer with a chain extender, if appropriate a chain-terminating agent and if appropriate further additives to form the polyurethane elastomer, and d) spinning the polyurethane elastomer to form a fiber, in which there are less than 15% by weight of further polyurethane elastomers in the fiber. The present invention further relates to a polyurethane elastomer fiber obtainable by such a process, to its use for producing textiles, for example wovens or knits, and also to the use of a polyurethane elastomer for producing such a fiber.

The present invention relates to a process for producing a polyurethane elastomer fiber, which comprises a) reacting polymeric diol with a substance reactive therewith to form an OH-terminated prepolymer, b) reacting the OH-terminated prepolymer with a diisocyanate to form an isocyanate-terminated prepolymer, c) reacting the isocyanate-terminated prepolymer with a chain extender, if appropriate a chain-terminating agent and if appropriate further additives to form the polyurethane elastomer, and d) spinning the elastomer to form a fiber, wherein there are less than 15% by weight of further polyurethane elastomers in the fiber. The present invention further relates to a polyurethane elastomer fiber obtainable by such a process, to its use for producing textiles, for example wovens or knits, and also to the use of a polyurethane elastomer for producing such a fiber.

Further embodiments of the present invention are discernible from the claims, the description and the examples. It will be understood that the aforementioned and hereinbelow still to be elucidated features of the subject matter of the present invention are utilizable not only in the particular combination indicated, but also in other combinations without leaving the realm of the present invention.

Elastic polyurethane fibers composed of at least 85% segmented polyurethanes based on, for example polyethers, polyesters and/or polycarbonates are well known. Yarns composed of such fibers are used for producing textiles, such as fabrics, which in turn are useful inter alia for foundation garments, stockings and sportswear, examples being bathing costumes and swimming trunks. Segmented polyurethane fibers are fibers comprising soft segments having a glass transition temperature below 0° C. and preferably below −30° C. and crystalline, hard segments.

Elastic polyurethane fibers, in particular polyurethaneurea fibers, possess outstanding elasticity and substantial extensibility combined with high residing forces. Owing to this outstanding combination of properties, they are widely used in the apparel sector. Such elastic polyurethane fibers and processes for producing them are described for example in U.S. Pat. No. 5,541,280, U.S. Pat. No. 6,692,828, EP 1401946, DE 19931255, JP 63-219620 and U.S. Pat. No. 6,503,996.

Disadvantages of these elastic polyurethaneurea fibers include, in some applications, an insufficient breaking extension, which in turn permits incorporation in textiles only under comparatively low pretension; a still substantial increase in tension at the customary wearing sector extensions of 200 to 400%, which can lead to an unpleasant sense of pressure particularly at high contents of elastic polyurethane fiber, as for example in medical bandages or support textiles and also in the case of cuffs, for example on socks or baby diapers and also a hysteresis behavior which is disadvantageous compared with rubber threads for example.

There are many applications where, for example, a substantially constant tension over a wide extension range is desirable. Textiles comprising such fibers would exert a substantially constant pressure on the wearer's body, irrespective of the extension in the wearing zone. This is particularly important for wovens used for example for medical bandages or in the case of cuffs, for example for baby diapers. Rubber fibers, which likewise have a flatter elastic plateau, are disadvantageous because of their vulnerability to oxidation; the difficulty of manufacturing low linear densities; and their potential to induce a latex allergy.

These disadvantages do not arise when a copolymer of tetrahydrofuran and 3-methyltetrahydrofuran is used to produce the polyurethane elastomer fibers. Such fibers are described for example in U.S. Pat. No. 5,000,899 and EP 1240229. But one disadvantage of these fibers is the poor availability of 3-methyltetrahydrofuran.

It is an object of the present invention to provide a polyurethane elastomer fiber which in terms of its performance profile resembles a fiber based on a copolymer of tetrahydrofuran and 3-methyltetrahydrofuran, specifically with regard to breaking extension, elastic plateau and stress-strain characteristics, but does not require any 3-methyltetrahydrofuran to produce.

We have found that this object is achieved by a process according to claim 1, which comprises a) reacting polymeric diol with a substance reactive therewith to form an OH-terminated prepolymer, b) reacting the OH-terminated prepolymer with a diisocyanate to form an isocyanate-terminated prepolymer, c) reacting the isocyanate-terminated prepolymer with a chain extender, if appropriate a chain-terminating agent and if appropriate further additives to form the polyurethane elastomer, and d) spinning the elastomer to form a fiber, in order to produce a polyurethane elastomer fiber, wherein there are less than 15% by weight of further polyurethane elastomers in the fiber. The object is further achieved by a fiber obtainable according to such a process.

The addition of further polyurethane elastomers to the fiber carries the risk of worsening the fiber's properties, in particular its extension properties, depending on the proportion of the further polyurethane elastomers. Against this background, a fiber in accordance with the present invention comprises less than 15% by weight, preferably less than 10% by weight, more preferably less than 5% by weight and particularly 0% by weight of further polyurethane elastomers.

Useful polymeric diols for the purposes of the present invention include polyetherols, polyesterols or polycaprolactone, for example polyethers and copolyethers comprising polytetrahydrofuran and derivatives thereof, such as polytetrahydrofuran glycol, poly(tetrahydrofuran-co-ethylene ether) glycol, polycarbonate glycols, such as poly(pentane-1,5-carbonate) glycol and poly(hexane-1,6-carbonate) glycol and poly(ethylene-co-propylene adipate) glycol and also polyesterols, such as polyesters of adipic acid, butanediol and neopentyl glycol, of adipic acid, butanediol and hexanediol, of adipic acid and butanediol, of adipic acid and hexanediol, of dodecanedioic acid and neopentyl glycol, or of sebacic acid and neopentyl glycol. Preference is given to using polycaprolactone, polyesters of adipic acid and butanediol, polytetrahydrofuran glycol, polyesters of adipic acid, butanediol and neopentyl glycol, polyesters of adipic acid, butanediol and hexanediol, polyesters of adipic acid and hexanediol, polyesters of dodecanedioic acid and neopentyl glycol, or polyesters of sebacic acid and neopentyl glycol or mixtures thereof. Particular preference is given to using polytetrahydrofuran glycol alone or in mixtures with further diols, in particular alone, as polymeric diol.

The number average molecular weight of the polymeric diol is preferably in the range from 200 to 4000 g/mol. When polytetrahydrofuran glycol is used as polymeric diol, the number-averaged molecular weight is preferably in the range from 200 to 2500 g/mol, more preferably in the range from 200 to 2100 g/mol, even more preferably in the range from 300 to 1100 g/mol and especially in the range from 500 to 800 g/mol.

A substance reactive with polymeric diol comprises a compound having groups reactive toward OH groups. Groups reactive toward OH groups herein include for example carboxylate groups or isocyanate groups, but not the OH group itself. A substance reactive with polymeric diol may be for example diisocyanate, a diacid or a derivative of a diacid. Preference is given to using aromatic compounds, but also aliphatic compounds, such as hexamethylene diisocyanate (HDI), 4,4′-diisocyanato-dicyclohexylmethane (HMDI) or isophorone diisocyanate (IPDI). Aromatic compounds comprise for example aromatic isocyanates, such as 2,2′-, 2,4′- and 4,4′-diphenyl-methane diisocyanate, the mixtures of various monomeric diphenylmethane diisocyanates, 2,4- or 2,6-tolylene diisocyanate (TDI) or mixtures thereof, naphthylene diisocyanate (NDI) or mixtures thereof, aromatic diacids, such as terephthalic acid and isophthalic acid, and also esters of aromatic diacids, such as terephthalic esters and isophthalic esters. Particular preference for use as substance reactive with polymeric diol is given to isophthalic acid or terephthalic acid and also aliphatic esters of isophthalic acid and of terephthalic acid, in particular isophthalic acid or dimethyl isophthalate.

Step a) is more preferably carried out by reacting polytetrahydrofuran glycol with isophthalic acid or dimethyl isophthalate.

The reaction to form the OH-terminated prepolymer is effected in the case of isocyanates by mixing polymeric diol and isocyanate at temperatures of preferably 20 to 120° C., more preferably 50 to 100° C. and especially in the range from 70 to 90° C. The reaction is preferably carried out without solvent. When a solvent is used, it is preferably a polar aprotic solvent such as N,N-dimethylacetamide or N,N-dimethyl-formamide. The diisocyanate is used in deficiency. The ratio of OH groups to isocyanate groups is preferably in the range from 1:0.8 to 1:0.5 and preferably in the range from 1:0.7 to 1:0.6. The reaction is complete when all of the isocyanate used has reacted. This reaction preferably proceeds without catalyst. When a catalyst is used, phosphoric acid for example may be used at a concentration of preferably 50 to 200 ppm, based on the reaction mixture.

When the substance which is used as being reactive with polymeric diol is an aromatic diacid or an ester of an aromatic diacid, the reaction takes place under esterification or transesterification conditions respectively. The reaction mixture is gradually heated under reduced pressure to a temperature in the range from 150 to 250° C. for example, in which by-produced product is removed by distillation. If appropriate, a Lewis acid can be used as a catalyst, but it is preferable not to employ a catalyst. When a catalyst is employed, it is possible to add for example boron trifluoroetherate, dimethyltin dilaurate, tin dioctoate and tetrabutyl orthotitanate, preferably in a concentration of 3 to 50 ppm, and in particular of 5 to 30 ppm. The molar ratio of polymeric diol to aromatic diacid or aromatic diacid ester is preferably in the range from 1:0.9 to 1:0.5, preferably in the range from 1:0.9 to 1:0.6. The number-averaged molecular weight of the OH-terminated prepolymer is preferably in the range from 500 to 5000 g/mol and more preferably in the range from 1500 to 4500 g/mol.

The diisocyanate used in step b) to prepare the isocyanate-terminated prepolymer can be any desired organic diisocyanate. Preferred diisocyanates include linear aliphatic isocyanates, such as 1,2-ethylene diisocyanate, 1,3-propylene diisocyanate, 1,4-butylene diisocyanate, 1,6-hexamethylene diisocyanate, 1,8-octamethylene diisocyanate, 1,5-diisocyanato-2,2,4-trimethylpentane, 3-oxo-1,5-pentane diisocyanate and the like; cycloaliphatic diisocyanates, such as isophorone diisocyanate, cyclohexane diisocyanates, preferably 1,4-cyclohexane diisocyanate, 4,4′-diisocyanato-dicyclohexylmethane (HMDI) and aromatic diisocyanates, such as 2,2′-, 2,4′- and 4,4′-diphenylmethane diisocyanate, the mixtures of various monomeric diphenylmethane diisocyanates, 2,4- or 2,6-tolylene diisocyanate (TDI) or mixtures thereof, naphthylene diisocyanate (NDI) or mixtures thereof. Particularly preferred diisocyanates are 4,4′-methylenediphenylene diisocyanate (4,4′-MDI), and 2,4- or 2,6-tolylene diisocyanate, in particular 4,4′-MDI.

The isocyanates are used in excess. Preferably, the ratio of OH groups of the OH-terminated prepolymer to isocyanate groups of the diisocyanate is in the range from 1:1.2 to 1:3.0, and preferably in the range from 1:1.3 to 1:2.0. The reaction is effected by mixing OH-terminated prepolymer and isocyanate at temperatures of preferably 20 to 120° C., more preferably 50 to 100° C. and in particular in the range from 70 to 90° C. The reaction is preferably carried out without solvent. When a solvent is used, it is preferably a polar aprotic solvent such as N,N-dimethylacetamide or N,N-dimethylformamide. The isocyanate content of the isocyanate-terminated prepolymer is preferably in the range from 0.1 to 3.75%, more preferably from 1 to 3%. This reaction preferably proceeds without catalyst. When a catalyst is used, phosphoric acid for example may be used at a concentration of preferably 50 to 200 ppm, based on the reaction mixture. Step b), as well as the polymeric OH-terminated prepolymer, utilizes preferably less than 15% by weight, more preferably less than 10% by weight, even more preferably less than 1% by weight and particularly nothing of a further compound having two or more isocyanate-reactive groups, based on the total weight of compounds having two isocyanate-reactive groups.

Useful chain extenders include compounds having two isocyanate-reactive hydrogen atoms and a molecular weight of less than 500 g/mol. Such substances are described for example in “Kunststoffhandbuch, 7, Polyurethane”, Carl Hanser Verlag, 3rd edition 1993, Chapter 3.4.3. There may be used for example ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexanediamine, 1,3-diamine-4-methylcyclohexane, 1-amino-3-aminoethyl-3,5,5-trimethylcyclohexane (isophoronediamine), 1,1′-methylenebis(4,4′-diamino-hexane), toluenediamine, piperazine, ethylene glycol, 1,2-propanediol, 1,3-propanediol, 1,4-butanediol, 1,5-pentanediol, 1,6-hexanediol or mixtures thereof. Particular preference is given to diamines, such as ethylenediamine, 1,2-propylenediamine, 1,3-propylenediamine, 1,4-butanediamine, 1,5-diaminopentane, hydrazine, m-xylylenediamine, p-xylylenediamine, 1,4-cyclohexanediamine, 1,3-cyclohexane-diamine, 1,3-diamine-4-methylcyclohexane, 1-amino-3-aminoethyl-3,5,5-trimethylcyclohexane (isophoronediamine), 1,1′-methylenebis(4,4′-diaminohexane) and toluenediamine and also mixtures thereof, in particular ethylenediamine and 1,2-propylenediamine and mixtures thereof.

As well as one or more chain-extending agents it is also possible to use isocyanate-reactive compounds that act as chain-terminating agents. Useful chain-terminating agents include for example secondary amines, such as diethylamine, dibutylamine, dicyclohexylamine or primary amines, such as ethanolamine, or a primary alcohols, such as n-butanol, alone or as mixtures. Preferably the chain-terminating agent is preferably a monofunctional amine. As well as chain-extending agents and chain-terminating agents it is possible to use specific amines, examples being diethylene-triamine or diethanolamine.

When a chain-terminating agent and/or a specific amine is or used as well as chain extender or extenders, the fraction of chain-extending agent or agents is preferably 85% by weight or more and more preferably 90% by weight or more, based on the total weight of chain extender, chain-terminating agent and specific amine.

These chain-terminating agents and the specific amines may each be used individually or together with the chain extenders. It is preferable to add the chain-terminating agents, the specific amine and the chain-extending agents separately. Separately means that the components can be added simultaneously in various, controllable streams or at different times.

A primary alcohol, such as n-butanol, may also be added to the polymeric diol before the preparation of the OH-terminated prepolymer. In this case, chain-terminating agents and/or specific amines can be included in step c) as well as the chain extender.

The conversion of the isocyanate-terminated prepolymer to the polyurethane elastomer of the present invention preferably takes place in solution. Polar aprotic solvents can be used. A polar aprotic solvent is a solvent which dissolves the isocyanate-terminated prepolymer, but is essentially unreactive with isocyanate groups. Examples of such solvents are N,N-dimethylacetamide, N,N-dimethylformamide, dimethyl sulfoxide, N-methylpyrrolidone or the like. Preference is given to using N,N-dimethylacetamide or N,N-dimethylformamide, particular preference is given to using N,N-dimethylacetamide. Preferably, the isocyanate-terminated prepolymer, the chain extenders, if appropriate the chain-terminating agents and if appropriate the specific amines are in each case dissolved in the solvent and the solutions obtained are subsequently mixed with one another. Preferably, the respective solutions are added separately to the solution of the isocyanate-terminated prepolymer. This can take place concurrently or at different times. Alternatively, the solutions of chain extender, chain-terminating agents and specific amine can be mixed prior to addition to the isocyanate-terminated prepolymer. The temperature at which the reaction takes place is preferably in the range from 0 to 80° C., more preferably in the range from 8 to 50° C. and in particular in the range from 10 to 35° C. Customarily, all isocyanate-reactive materials are used in such an amount that there is a small excess of isocyanate-reactive groups, generally amino groups. The ratio of isocyanate groups to amine groups is preferably in the range from 1:1.00 to 1:1.15, more preferably in the range from 1:1.00 to 1:1.04 and in particular in the range from 1:1.00 to 1:1.02.

The fully reacted solution is subsequently spun to form a fiber. Any spinning process whereby a fiber in accordance with the present invention can be produced can be used. Such spinning processes are described for example in “Kunststoffhandbuch, 7, Polyurethane”, Carl Hanser Verlag, 3rd edition 1993, Chapter 13.2. These include dry-spinning or wet-spinning processes, preferably the dry-spinning process. In the spinning process, a spinning solution comprising the polyurethane elastomer of the present invention is spun through a spinneret die to form threads. Removing the spinning solvent, for example by drying or in a coagulation bath, gives the polyurethane elastomer fibers of the present invention.

The polyurethane elastomer fibers of the present invention may further comprise additives. Any additives known for segmented polyurethane elastomer fibers can be used herein. For example, delusterants, fillers, antioxidants, dyes, pigments, dye enhancers, for example Methacrol 2462 B, and stabilizers against heat, light, UV radiation, chlorinated water and against the action of gas fumes and air pollution such as NO or NO₂ may be included. Examples of antioxidants, stabilizers against heat, light or UV radiation are stabilizers from the group of the sterically hindered phenols, for example Cyanox 1790, hindered amine light stabilizers (HALS), triazines, benzophenones and the benzotriazoles. Examples of pigments and delusterants are titanium dioxide, magnesium stearate, silicone oil, zinc oxide and barium sulfate. Examples of dyes are acidic dyes, disperse dyes and pigments and optical brighteners. Examples of stabilizers against fiber degradation by chlorine or chlorinated water are zinc oxide, magnesium oxide, or coated or uncoated magnesium aluminum hydroxycarbonates, for example hydrotalcites or huntites.

A polyurethane elastomer fiber in accordance with the present invention has advantageous properties with regard to breaking extension, hysteresis behavior and stress-strain behavior. This advantageous behavior is characterized using solution-cast polyurethane elastomer films 0.20 to 0.26 mm in thickness. These are obtainable by pouring the spinning solution onto a planer surface and removing the solvent by drying.

Breaking extension is that change in length of an extended sample, expressed as % of the original length, at which the sample breaks. The measurement is carried out in accordance with ISO 37. The breaking extension of a polyurethane elastomer film in accordance with the present invention is preferably greater than 500% and more preferably greater than 600%.

Stress-strain behavior is determined in accordance with ISO 37. The stress of a polyurethane elastomer film in accordance with the present invention at 200% elongation in relation to the original length of the sample is preferably less than 6 N/mm² and more preferably less than 5 N/mm², at 300% elongation it is preferably less than 8 N/mm² and more preferably less than 7 N/mm², and at 400% elongation it is preferably less than 11 N/mm² and more preferably less than 10 N/mm².

The hysteresis behavior of a polyelastomer film in accordance with the present invention is reported in the relative loss of force on 5-tuply repeated elongation (b_{w, 5}), the hysteresis characteristic in the fifth elongation (H₅) and the tensile stress number in the 5th elongation (C₅). The measurements are carried out in accordance with German standard specification DIN 53825 Part 2. The relative loss of force on 5-tuply repeated elongation indicates the % change in length after the 5th elongation by 300%. The result for a sample which is in accordance with the present invention is preferably a b_{w, 5} value of more than 25% and more preferably of not more than 20%. The hysteresis characteristic indicates the ratio of the unload force to the load force at 150% elongation in the 5th elongation. The tensile stress number indicates the ratio of the tensile force for a 150% elongation under load to the tensile force for 300% elongation in the 5th elongation.

The polyurethaneurea fibers of the present invention are useful for producing elastic textiles, for example wovens, knits and other textile goods.

The examples which follow illustrate the invention.

Polyurethane elastomers were prepared and their properties determined by way of example.

### EXAMPLE 1

### Polyurethane Elastomer from PolyTHF 1000-Homopolymer, TDI 80/20 as Primary Reagent

510.29 g (516.0 mmol) of devolatilized PolyTHF 1000-Homopolymer (BASF) are reacted with 58.92 g (338.3 mmol) of TDI 80/20 at 88° C. for 50 min. After the reaction has ended, the OH number is found to be 37.0 mg KOH/g (Mn=3033 g/mol). 401.03 g (132.3 mmol) of this OH-terminated prepolymer are reacted for 50 min at 88° C. with 53.90 g (215.4 mmol) of 4,4′-MDI. After the reaction has ended, the NCO content is 1.49% and the viscosity is 313 000 mPa*s at 60° C. The NCO-terminated prepolymer is dissolved in N,N-dimethylacetamide at 23.5% solution and chain extension is carried out with ethylenediamine in N,N-dimethylacetamide such that the amine excess relative to titrated NCO content (0.36%) is 2.22 mmol of NH₍₂₎ per kg of polyurethane elastomer polymer. For handleability and reproducibility reasons, the mechanical properties of the polyurethane elastomer are measured on films. To this end, a solution of the polyurethane elastomer prepared is filmed by pouring the solution onto a precisely horizontally aligned glass plate and allowing it to dry at 50° C. in a slow N₂ stream for 48 h. Solution amount and concentration and also plate area are matched to each other so as to produce a film about 0.2 to 0.26 mm in thickness. The films are mechanically tested in accordance with a) DIN 53504 (tensile test) and b) DIN 53835 (hysteresis). The measured results are summarized in table 1. The trends of the values obtained are essentially in line with those of the fibers. The molar masses of the polyurethaneurea elastomers obtained were determined by gel permeation chromatography (GPC), calibrated with samples of polymethyl methacrylate (PMMA).

### EXAMPLE 2

### Polyurethane Elastomer from PolyTHF 1000-Homopolymer, Dimethyl Terephthalate as Primary Reagent, Chain-Terminating Amine

508.33 g (514.0 mmol) of devolatilized PolyTHF 1000-Homopolymer (BASF) are reacted with 65.44 g (337.0 mmol) of dimethyl terephthalate in the presence of 20 ppm of tetrabutyl orthotitanate by gradually raising the temperature and reducing the pressure (finally to 240° C./7 mbar); methanol formed is removed by distillation. After the reaction has ended, the OH number is found to be 32.0 mg KOH/g (Mn=3507 g/mol). 412.09 g (117.5 mmol) of this material are reacted with 47.9 g (191.4 mmol) of 4,4′-MDI at 88° C. for 50 min, leading to a prepolymer having a 1.38% NCO content and a 166 500 mPa*s viscosity at 60° C. 32.9 g of the NCO-terminated prepolymer are used to prepare a 23.5% by weight solution in N,N-dimethylacetamide and chain extension is carried out with 288.2 mg (4.710 mmol) of amine mixture, dissolved in 26.2 g of N,N-dimethylacetamide. The amine mixture consists of 90% by weight of ethylenediamine and 10% by weight of diethylamine (average molar mass 61.19 g/mol, functionality 1.916). Amine excess based on the NCO content is 5.81 mol %. The properties of the polyurethane elastomer thus obtained were tested similarly to Example 1. The measured results are summarized in table 1.

### EXAMPLE 3

### Polyurethane Elastomer from PolyTHF 1000-Homopolymer, Dimethyl Isophthalate as Primary Reagent

452.05 g (457.1 mmol) of devolatilized PolyTHF 1000-Homopolymer (BASF) are reacted with 58.2 g (299.8 mmol) of dimethyl isophthalate in the presence of 20 ppm of tetrabutyl orthotitanate as under 2). The OH number of the OH-terminated prepolymer is found to be 39.8 mg KOH/g (Mn=2820 g/mol). 467.57 g (165.8 mmol) thereof are reacted with 67.18 g (268.4 mmol) 4,4′-MDI at 88° C. for 50 min to form an NCO-terminated prepolymer having a 1.47% NCO content and 156 300 mPa*s at 60° C. 32.9 g of this material are diluted with 107.1 g of N,N-dimethylacetamide. A solution of 296 mg (4.93 mmol) of ethylenediamine in 25.9 g of N,N-dimethylacetamide is added as described above. The testing of the properties of the polyurethane elastomer thus obtained is carried out similarly to Example 1. The measured results are summarized in table 1.

### EXAMPLE 4

### Polyurethane Elastomer from PolyTHF 1000-Homopolymer, Dimethyl Isophthalate as Primary Reagent, Chain-Terminating Amine

500.81 g (506.4 mmol) of devolatilized PolyTHF 1000-Homopolymer (BASF) are reacted with 64.47 g (332.1 mmol) of dimethyl isophthalate in the presence of 20 ppm of tetrabutyl orthotitanate as described in Example 2. The resulting OH number is 45.0 mg KOH/g (Mn=2494 g/mol). Reaction of 466.10 g (186.9 mmol) of the OH-terminated prepolymer with 75.3 g (300.9 mmol) of 4,4′-MDI gives the NCO-terminated prepolymer having a 1.38% NCO content. 32.9 g thereof are dissolved in 107.1 g of N,N-dimethylacetamide and admixed with 340 mg (5.56 mmol) of a mixture of ethylenediamine and diethylamine, dissolved in 26.13 g of N,N-dimethylacetamide, as described above. The testing of the properties of the polyurethane elastomer thus obtained is carried out similarly to Example 1. The measured results are summarized in table 1.

### EXAMPLE 5

### Polyurethane Elastomer from PolyTHF 650-Homopolymer, Dimethyl Isophthalate as Primary Reagent

475.46 g (738.3 mmol) of devolatilized PolyTHF 650-Homopolymer (BASF) are reacted with 110.75 g (570.4 mmol) of dimethyl isophthalate under catalysis by 20 ppm of tetrabutyl orthotitanate as described above. The OH number after the reaction has ended is 37.33 mg KOH/g (Mn=3006 g/mol). 436.69 g (145.3 mmol) of the prepolymer is reacted with 58.86 g (235.2 mmol) of 4,4′-MDI. The NCO content after the reaction has ended was 1.15% and the viscosity at 60° C. was 169 700 mPa·s. 32.9 g thereof are dissolved in 107.1 g of N,N-dimethylacetamide and admixed with 135.4 mg (2.253 mmol) of ethylenediamine in 25.36 g of N,N-dimethylacetamide as indicated above. The testing of the properties of the polyurethane elastomer thus obtained is carried out similarly to Example 1. The measured results are summarized in table 1.

### EXAMPLE 6

### Polyurethane Elastomer from PolyTHF 650-Homopolymer, Dimethyl Isophthalate as Primary Reagent, Chain Terminator Amine

32.9 g of NCO-terminated prepolymer from Example 5 are dissolved in 107.1 g of N,N-dimethylacetamide. A solution of 300.9 mg (4.917 mmol) of ethylenediamine-diethylamine mixture, weight ratio 90:10, in 28.41 g of N,N-dimethylacetamide is added as described above for chain extension. The testing of the properties of the polyurethane elastomer thus obtained is carried out similarly to Example 1. The measured results are summarized in table 1.

### COMPARATIVE EXAMPLES

### Comparative Example 1

### Polyurethane Elastomer from 3-methyl-THF-THF Copolymer

210.7 g (72.24 mmol) of 3-methyl-THF-THF copolymer (PTG-L 3000, Hodogaya Chemical Company), which had been devolatilized at 120° C./2 mbar for one hour, are reacted with 29.44 g (117.6 mmol) of 4,4′-MDI at 88° C. for 80 min. 32.90 g of this NCO-terminated prepolymer are fully dissolved in 107.10 g of N,N-dimethylacetamide at 30° C. under nitrogen. This solution is admixed with 374 mg (6.22 mmol) of ethylenediamine in 107.1 g of N,N-dimethylacetamide in the course of 31 min by stirring at 30° C. The amino excess based on the titrated NCO content in solution is 4.00 mol %. The testing of the properties of the polyurethane elastomer thus prepared is carried out similarly to Example 1. The measured results are summarized in table 1.

### Comparative Example 2

### Polyurethane Elastomer from PolyTHF 1800-Homopolymer

196.18 g (108.09 mmol) of devolatilized PolyTHF 1800-Homopolymer (BASF) are reacted with 43.82 g (175.1 mmol) of 4,4′-MDI similarly to Comparative Example 1. 32.90 g of the prepolymer thus prepared are dissolved in 107.1 g of N,N-dimethyl-acetamide at 30° C. A mixture of 63.33% by weight of ethylenediamine, 19.49% by weight of 1,2-propanediamine and 17.18% by weight of diethylamine is used for chain extension. 631 mg of this amine mixture are dissolved in 25.99 g of N,N-dimethyl-acetamide and are added at 30° C. to the prepolymer solution in the course of 31 min. The testing of the properties of the polyurethane elastomer thus prepared is carried out similarly to Example 1. The measured results are summarized in table 1.

TABLE 1

| | Comparative | Comparative | Example | Example | Example | Example | Example | Example |
|---|---|---|---|---|---|---|---|---|
| | Example 1 | Example 2 | 1 | 2 | 3 | 4 | 5 | 6 |
| PTHF | 3-Me-THF/THF. | PTHF 1800 | PTHF 1000 | PTHF 1000 | PTHF 1000 | PTHF 1000 | PTHF 650 | PTHF 650 |
| Prepolymer method/reagent | normal | normal | TDI | DMT | DMIPT | DMIPT | DMIPT | DMIPT |
| OH-terminated prepolymer | | | | | | | | |
| Mn from OH number | — | — | 3000 | 3500 | 2800 | 2500 | 3000 | 3000 |
| NCO-terminated prepolymer | | | | | | | | |
| NCO-content after reaction | 1.83 | 2.55 | 1.60 | 1.38 | 1.47 | 1.38 | 1.15 | 1.15 |
| Polyurethane elastomer | | | | | | | | |
| Viscosity 30° C., 20% solution | | | | | | | | |
| [MPas] | 380 000 | 5070 | 112 700 | 28 800 | 237 900 | 555 | 61 890 | 5924 |
| Mₙ (GPC, PMMA) | 68000 | 41 000 | 46 000 | 37 000 | 43 000 | 44 000 | 60 000 | 37 000 |
| M_{w}/Mₙ (GPC, PMMA) | 5.8 | 4.5 | 4.4 | 5.1 | 5.1 | 5.2 | 4.4 | 3.7 |
| Tensile testing | | | | | | | | |
| Modulus of elasticity [MPa] | 8 | 13 | 5 | 7 | 6 | 10 | 5 | 10 |
| Tensile strength [MPa] | 50.3 | 57.9 | 55.0 | 45.8 | 51.5 | 56.1 | 32.2 | 46.4 |
| Breaking extension [%] | 699.7 | 642.7 | 592.8 | 678.1 | 585.2 | 566.9 | 724.3 | 752.4 |
| Stress at 200% elongation | 5.23 | 6.54 | 4.12 | 3.71 | 4.57 | 4.34 | 2.54 | 4.46 |
| [N/mm²] | | | | | | | | |
| Stress at 300% elongation | 7.18 | 9.49 | 6.02 | 5.20 | 6.60 | 6.37 | 3.25 | 5.92 |
| [N/mm²] | | | | | | | | |
| Stress at 400% elongation | 9.08 | 13.03 | 7.60 | 6.93 | 8.26 | 8.59 | 3.99 | 7.21 |
| [N/mm²] | | | | | | | | |
| Hysteresis | | | | | | | | |
| b_{w.5} | 0.10 | 0.16 | 0.14 | 0.13 | 0.12 | 0.12 | 0.09 | 0.10 |
| H₅ | 0.88 | 0.70 | 0.85 | 0.78 | 0.81 | 0.80 | 0.88 | 0.88 |
| C₅ | 0.45 | 0.34 | 0.45 | 0.50 | 0.48 | 0.45 | 0.59 | 0.42 |
| Special test A (elastic recovery) | | | | | | | | |
| Residue extension difference after | 3.56 | 4.84 | 4.76 | 3.80 | 3.33 | 3.41 | 5.27 | 4.91 |
| 200% elongation. (0 s-300 s) [%] | | | | | | | | |
| Residue extension difference after | 6.87 | 18.90 | 7.63 | 6.42 | 5.86 | 6.88 | 8.44 | 8.87 |
| 400% elongation. (0 s-300 s) [%] | | | | | | | | |
| Special test B (extension loss) | | | | | | | | |
| Tension loss at 200% elongation | 15.33% | 19.74% | 15.68% | 14.48% | 14.47% | 14.15% | 11.58% | 16.29% |
| 300 s/0 s [%] | | | | | | | | |

Table 1 shows that the polyurethane elastomers produced according to the present invention are superior to a customary prior art polyurethane elastomer particularly with regard to the targeted low modulus of elasticity, as desired for some applications, the stress-strain behavior, the hysteresis behavior and the elastic recovery. In some instances, the elastomers of the present invention even exceed the particularly advantageous values of a polymer based on a copolymer of THF and 3-methyl-THF.

1. A process for producing a polyurethane elastomer fiber, which comprises
a) reacting polymeric diol with a diacid or a derivative of a diacid to form an OH-terminated prepolymer,
b) reacting the OH-terminated prepolymer with a diisocyanate to form an isocyanate-terminated prepolymer,
c) reacting the isocyanate-terminated prepolymer with a chain extender, if appropriate a chain-terminating agent and if appropriate further additives to form a polyurethane elastomer, and
d) spinning the elastomer to form a fiber,
wherein the level of further compounds having two or more isocyanate-reactive groups, based on the total weight of compounds having two isocyanate-reactive groups in step b), is less than 15% by weight and there is less than 15% by weight of further polyurethane elastomers in the fiber.

2. The process according to claim 1 wherein the isocyanate-terminated prepolymer is further reacted with a chain-terminating agent in step c).

3. The process according to claim 2 wherein the chain-terminating agent comprises a primary amine, a secondary amine, a primary alcohol or mixtures thereof.

4. The process according to claim 1 wherein the polymeric diol is polytetrahydrofuran glycol having a number average molecular weight in the range from 200 to 2500 g/mol.

5. The process according to claim 1 wherein the diol-reactive substance is terephthalic acid, isophthalic acid and/or an ester of terephthalic acid and/or of isophthalic acid.

6. The process according to claim 5 wherein the diol-reactive substance is isophthalic acid or dimethyl isophthalate.

7. The process according to claim 1 wherein the number average molecular weight of the OH-terminated prepolymer is in the range from 500 to 5000 g/mol.

8. The process according to claim 1 wherein the diisocyanate of step b) is 4,4′-diphenylmethane diisocyanate or 2,4- or 2,6-tolylene diisocyanate.

9. The process according to claim 1 wherein the chain extender is ethylenediamine.

10. The process according to claim 1 wherein further additives are added before the spinning in step d).

11. An elastomer fiber obtainable by a process according to claim 1.

12. The use of the fiber according to claim 11 for producing textiles.

13. The use of the polyurethane elastomer obtainable by
a) reacting a polymeric diol with a diacid or a derivative of a diacid to form an OH-terminated prepolymer,
b) reacting the OH-terminated prepolymer with a diisocyanate to form an isocyanate-terminated prepolymer,
c) reacting the isocyanate-terminated prepolymer with a chain extender, if appropriate a chain-terminating agent and if appropriate further additives to form a polyurethane elastomer,
for producing an elastomer fiber according to claim 11, wherein the level of further compounds having two or more isocyanate-reactive groups, based on the total weight of compounds having two isocyanate-reactive groups in step b), is less than 15% by weight and there is less than 15% by weight of further polyurethane elastomers in the fiber.

14. An elastomer fiber obtained by the process according to claim 1.
